(19) United States
(12) Patent Application Publication
(10) Pub. No.: US 2013/0106225 A1
(43) Pub. Date: May 2, 2013

(54) SPINDLE MOTOR

(71) Applicant: Yeol CHOI, Suwon (KR)

(72) Inventor: Yeol CHOI, Suwon (KR)

(21) Appl. No.: 13/620,642

(22) Filed: Sep. 14, 2012

(30) Foreign Application Priority Data
Nov. 1, 2011 (KR) 10-2011-0112696

(51) Int. Cl. H02K 21/02

(52) U.S. Cl. 310/156.04

(57) ABSTRACT

There is provided a spindle motor including: a holder having a motor shaft system mounted thereon and including a stator providing rotational driving force to a rotating member; a first pulling magnet mounted on an upper portion of an outer edge of the stator in a radial direction; and a second pulling magnet mounted on a lower portion of the rotating member and preventing excessive floating of the rotating member due to attractive force between the first and second pulling magnets.

### CROSS-REFERENCE TO RELATED APPLICATIONS

This application claims the priority of Korean Patent Application No. 10-2011-0112696 filed on Nov. 1, 2011, in the Korean Intellectual Property Office, the disclosure of which is incorporated herein by reference.

### BACKGROUND OF THE INVENTION

1. Field of the Invention

The present invention relates to a spindle motor.

2. Description of the Related Art

In accordance with the recent trend for the miniaturization of electronic devices, the capacity of a storage memory has continuously increased. Therefore, demand for miniaturization and high speed rotation of a spindle motor used in a driving device for a large capacity memory storage device such as an optical disk, or a slim optical disc drive (ODD) has increased.

In the case in which the spindle motor rotates at a high speed, stable rotation of a disk driven thereby is required, which requires stable rotation of a rotor. Various attempts have been undertaken to solve this technical problem.

In the spindle motor used in the ODD driver according to the related art, an annular pulling magnet disposed above a holder has been used. The pulling magnet allows uniform attractive force to act on the entire rotor, such that vertical rotor vibrations may be reduced. However, in this case, rotor vibrations may be generated due to non-uniformity of a mass according to an assembly state of a turntable or a tolerance between a shaft and a bearing. Particularly, recently, as a light-scribe function has been added to disk drive devices, the rotor vibrations may cause degradation of printing quality in a low speed rotation region and a data error in a high speed rotation region in which data is read and written.

### SUMMARY OF THE INVENTION

An aspect of the present invention provides a spindle motor in which a rotating member (a rotor) may rotate stably.

According to an aspect of the present invention, there is provided a spindle motor including: a holder having a motor shaft system mounted thereon and including a stator providing rotational driving force to a rotating member; a first pulling magnet mounted on an upper portion of an outer edge of the stator in a radial direction; and a second pulling magnet mounted on a lower portion of the rotating member and preventing excessive floating of the rotating member due to attractive force between the first and second pulling magnets.

The first pulling magnet may be provided along an outer diameter of the stator in the circumferential direction.

The second pulling magnet may be provided to face the first pulling magnet.

The first pulling magnet and the stator may include a yoke interposed therebetween, the yoke being formed of a non-magnetic material.

The first pulling magnet may be inserted into the yoke in which only an upper portion corresponding to a location at which the first pulling magnet faces the second pulling magnet is opened, and may be provided in the stator, the yoke being formed of the non-magnetic material.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view of a spindle motor according to an embodiment of the present invention;

FIG. 2 is a plan view of a fixed member including a shaft inserted thereinto in the spindle motor according to the embodiment of the present invention;

FIG. 3 is an exploded perspective view of the fixed member including the shaft inserted thereinto in the spindle motor according to the embodiment of the present invention; and

FIG. 4 is a cross-sectional perspective view of a rotating member (a rotor) in the spindle motor according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

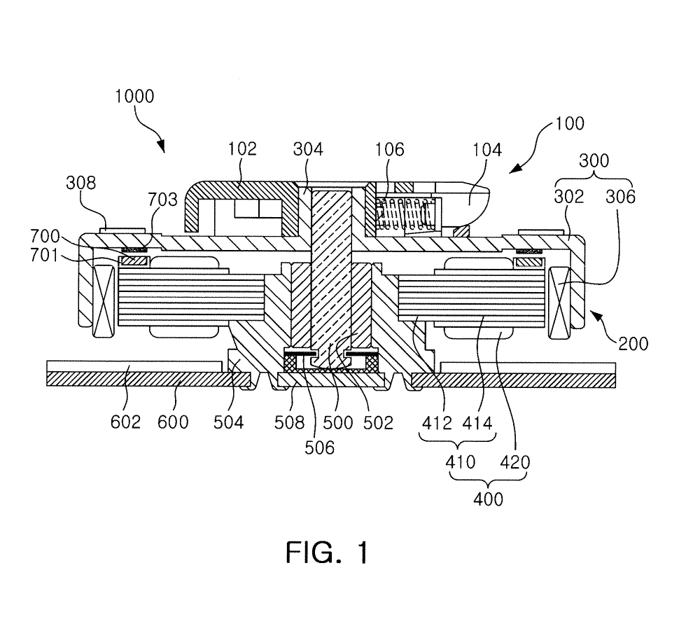

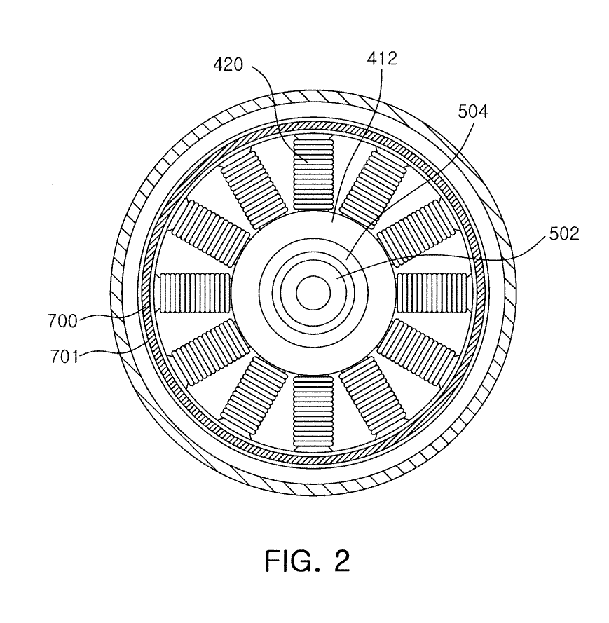

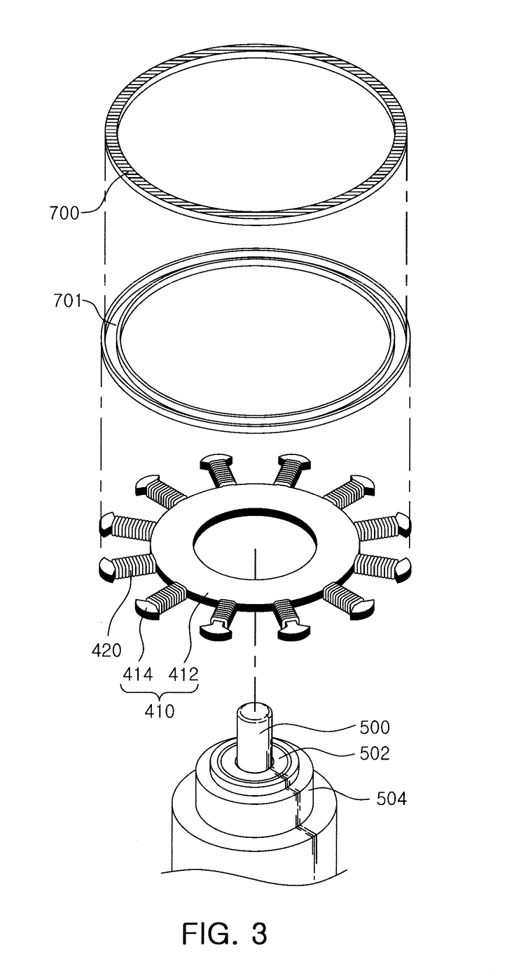

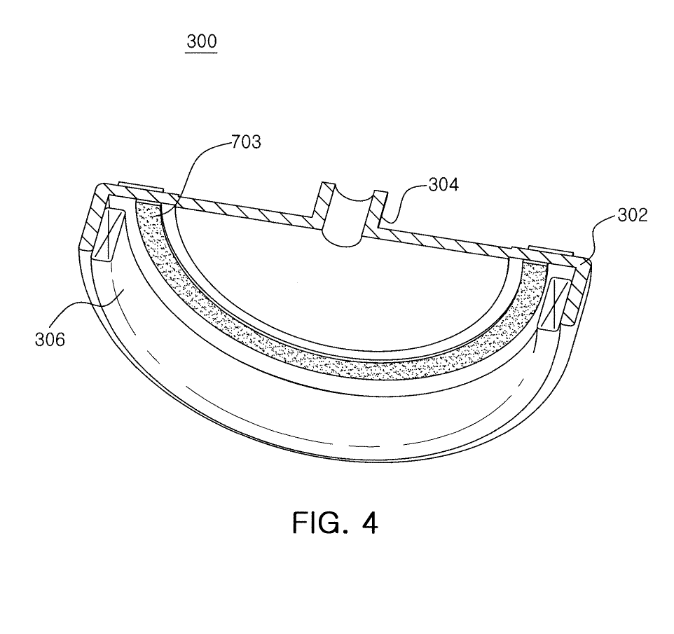

FIG. 1 is a schematic cross-sectional view of a spindle motor according to an embodiment of the present invention; FIG. 2 is a plan view of a fixed member including a shaft inserted thereinto in the spindle motor according to the embodiment of the present invention; FIG. 3 is an exploded perspective view of the fixed member including the shaft inserted thereinto in the spindle motor according to the embodiment of the present invention; and FIG. 4 is a cross-sectional perspective view of a rotating member (a rotor) in the spindle motor according to the embodiment of the present invention.

Referring to FIGS. 1 through 4, an optical disk drive (ODD) driver 1000 according to the embodiment of the present invention may include a chucking device 100 and a spindle motor 200. The chucking device 100 may be a device detachably coupling a disk to the ODD driver 1000 and transferring driving force of the spindle motor 200 to the disk.

Terms with respect to directions will first be defined. As viewed in FIG. 1, an axial direction refers to a vertical direction based on a shaft 500, and an outer diameter or inner diameter direction refers to a direction towards an outer edge of a rotor 300 based on the shaft 500 or a direction towards the center of the shaft 500 based on the outer edge of the rotor 300.

In addition, a circumferential direction refers to a direction in which the shaft 500 rotates based on the shaft 500.

The chucking device 100 may include a housing 102, a chuck pin 104 inserted into the housing 102 so as to protrude outwardly of the housing 102, a coil spring 106 elastically supporting the chuck pin 104. In this configuration, an inner peripheral surface of the disk is closely adhered to outer peripheral surfaces of the chuck pin 104 and the housing 102, such that the disk may be fixed onto the spindle motor 200. A friction member 308 may be coupled to an upper surface of the rotor 300 to more firmly support the disk.

The spindle motor 200 may include the rotor 300 to which a driving magnet 306 is coupled, the shaft 500 coupled to the rotor 300, a bearing 502 rotatably supporting the shaft 500, a holder 504 supporting the bearing 502, a stator 400 coupled to an outer peripheral surface of the holder 504 so as to be adjacent to the driving magnet 306, and a first pulling magnet 700 coupled to an upper portion of an outer edge of the stator 400 while facing the rotor 300 so that the center of an outer diameter of the stator 400 is biased toward one side based on the center of the shaft 500. Therefore, attractive force acts between the first pulling magnet 700 and a second pulling magnet 703 mounted on the rotor 300 to thereby be uniformly provided to the entire rotor 300, such that the disk may rotate stably. As a result, noise or power waste generated at the time of high speed rotation may be prevented.

Here, the first pulling magnet 700 may be provided along the outer diameter of the stator 400 in the circumferential direction. In addition, the second pulling magnet 703 to be described below may be mounted in a position corresponding to the first pulling magnet 700 on a portion of the rotor 300 facing the stator 400. More specifically, in the case in which the first pulling magnet 700 has an annular shape, the second pulling magnet 703 may also have an annular shape.

The rotor 300 may include a rotor case 302 and the driving magnet 306. An upper portion of the rotor case 302 may be provided with a burring part coupled to the shaft 500. The burring part 304 may include a through-hole formed at the center thereof and protrude upwardly.

An inner peripheral surface of the burring part 304 may be coupled to the shaft 500, and an outer peripheral surface thereof may be coupled to an inner peripheral surface of the housing 102 of the chucking device 100. Meanwhile, the rotor case 302 may be formed of a magnetic material such as iron.

A lower portion of the rotor case 302 may protrude downwardly and have the driving magnet 306 coupled to an inner peripheral surface thereof. The driving magnet 306 electromagnetically interacts with the stator 400 to generate the driving force, such that the rotor 300 may rotate.

In addition, the rotor case 302 among the rotating members may include the second pulling magnet 703 provided on the inner peripheral surface thereof and at a position corresponding to the first pulling magnet 700 to allow the attractive force to act between the first and second pulling magnets 700 and 703. Therefore, the attractive force is uniformly provided to the entire rotor 300, such that the disk may rotate stably. As a result, the noise or the power waste generated at the time of high speed rotation may be prevented.

The shaft 500 may have one side inserted into the burring part 304 of the rotor case 302 to thereby be coupled thereto and the other side rotatably supported by the bearing 502. The bearing 502 may be formed of a sintered body and be an oil containing bearing having lubricating oil contained in the sintered body.

The bearing 502 may have a predetermined clearance between the bearing 502 and the shaft 500. Therefore, when the shaft 500 rotates, the lubricating oil contained in the sintered body is filled in the clearance, such that the shaft 500 may smoothly rotate.

The holder 504 may support the bearing 502. The holder 504 may include a through-hole formed at the center thereof.

The bearing 502 is inserted into the through-hole, such that the bearing 502 may be supported. The outer peripheral surface of the holder 504 may be coupled to an inner peripheral surface of the stator 400 while contacting the inner peripheral surface of the stator 400.

A cover plate 508 may be coupled into the through-hole of the holder 504 to support the shaft 500 in the vertical direction. The cover plate 508 and a lower surface of the shaft 500 may include a washer 506 interposed therebetween to prevent separation of the shaft 500 and friction between the cover plate 508 and the shaft 500.

The holder 504 may be coupled to the base member 600. The holder 504 may support the shaft 500 at an inner portion thereof and support the stator 400 at an outer portion thereof. As a result, the holder 504 may fix the shaft 500 and stator 400 to the base member 600.

The stator 400 may include a stator core 410 and a coil 420. The stator core 410 may include an annular body 412 and a plurality of teeth 414 extended outwardly of the body 412, wherein the teeth 414 may include the coil 420 wound therearound. An edge of the teeth 414 may face the driving magnet 306.

Meanwhile, a printed circuit board 602 may be coupled onto the base member 600 to provide electric connection to the coil 420 wound around the core 410.

In addition, the pulling magnet 700 according to the embodiment of the present invention may be provided at the upper portion of the outer edge of the stator 400, as shown in FIGS. 2 through 4. The pulling magnet is provided at the outer edge of the stator 400 to prevent excessive floating of the rotor 300, whereby efficiency of the pulling magnet 700 may be significantly increased. That is, the pulling magnet 700 is provided at a position as distant as possible from the shaft 500 provided as the center of the rotation, in the outer diameter direction, such that the attractive force may be significantly increased.

In addition, the first pulling magnet 700 may be provided along an outer diameter of the stator 400 in the circumferential direction to generate biasing force. According to the related art, the annular pulling magnet was provided at the upper portion of the inner edge of the stator to allow the attractive force to uniformly act between the stator and the rotor in the circumferential direction, to thereby prevent the excessive floating of the rotor. However, in this structure, vibration or noise is generated in the rotor even in the case in which small external force is applied, such that the motor may not be accurately operated. Therefore, the present invention is to apply relatively stronger attractive force to the rotor to improve vibration and noise characteristics of the motor. Here, the first pulling magnet 700 may be a permanent magnet.

In addition, the second pulling magnet 703 may be provided on the inner surface of the rotor case 302 so that it corresponds to the first pulling magnet 700 to allow the attractive force therebetween. The second pulling magnet 703 may have a shape corresponding to that of the first pulling magnet 700 and face the first magnet 700. The second pulling magnet 703 may also not accurately face the first magnet 700 as long as magnetic force may act therebetween. The second pulling magnet 703 may also be a permanent magnet.

The second pulling magnet 703 interacts with the first pulling magnet 700 to allow the attractive force to act therebetween, such that relatively stronger attractive force may be generated.

Meanwhile, in the case in which the first pulling magnet 700 is directly coupled to the stator 400, since a material of the stator 400 is a magnetic material such as iron, the stator 400 may serve as a yoke with respect to the first pulling magnet 700.

Further, the first pulling magnet 700 and the stator 400 may include a yoke 701 interposed therebetween, wherein the yoke 701 is formed of a non-magnetic material. The yoke 701 may have a shape in which only an upper portion thereof corresponding to a location at which the first pulling magnet 700 faces the rotor 300 is opened. The reason is that the first pulling magnet 700 is not affected by the magnetic force acting between the stator 400 and the driving magnet 306.

Meanwhile, according to an embodiment of the present invention, a motor shaft system indicates a location at which a structure in which the shaft 500 may be rotatably coupled to the base member 600 to rotate is formed, and may include the bearing 502, the holder 504, and the shaft 500.

In addition, according to an embodiment of the present invention, a fixed member may include the base member 600, the bearing 502, the holder 504, the washer 502, the cover plate 508, and the stator 400, and the rotating member, a rotating member with respect to the fixed member, may include the shaft 500 and the rotor 300.

As described above, the pulling magnets 700 and 703 allowing the attractive force to act therebetween may be provided to provide the attractive force to the rotor 300, whereby relatively more increased attractive force may be uniformly provided to the entire rotor 300.

The pulling magnets 700 and 703 may provide the attractive force to the entire rotor 300 to reduce the vibration generated in the case in which the rotor 300 rotates at a high speed. In a high speed rotation region, due to reduction in the rotor (300) vibrations, generation of the noise due to the vibrations may be reduced, unnecessary power consumption may be reduced, and an operation temperature of the spindle motor 200 may be lowered.

Operation characteristics of the spindle motor may be improved due to the use of the pulling magnets 700 and 703 to reduce an error generated in the ODD driver 1000 in reading and writing data, whereby the performance of the spindle motor may be improved.

Further, the pulling magnets 700 and 703 may provide the stronger attractive force to the entire rotor 300, such that stable motion characteristics of the spindle motor may be implemented in a relatively low speed rotation region and generation of unstable noise, the vibration, or the like, caused by providing attractive force to the rotor 300 according to the related art may be suppressed.

As set forth above, according to the embodiment of the present invention, stronger attractive force is provided to the entire rotor, whereby the rotor may rotate stably. In addition, due to the stable rotation of the rotor, the noise or the power waste generated at the time of high speed rotation may be prevented.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a holder having a motor shaft system mounted thereon and including a stator providing rotational driving force to a rotating member;
a first pulling magnet mounted on an upper portion of an outer edge of the stator in a radial direction; and
a second pulling magnet mounted on a lower portion of the rotating member and preventing excessive floating of the rotating member due to attractive force between the first and second pulling magnets.

2. The spindle motor of claim 1, wherein the first pulling magnet is provided along an outer diameter of the stator in a circumferential direction.

3. The spindle motor of claim 1, wherein the second pulling magnet faces the first pulling magnet.

4. The spindle motor of claim 1, wherein the first pulling magnet and the stator include a yoke interposed therebetween, the yoke being formed of a non-magnetic material.

5. The spindle motor of claim 1, wherein the first pulling magnet is inserted into the yoke in which only an upper portion corresponding to a location at which the first pulling magnet faces the second pulling magnet is opened, and is provided in the stator, the yoke being formed of the non-magnetic material.
